(19) United States
(12) Patent Application Publication
(10) Pub. No.: US 2008/0127182 A1
(43) Pub. Date: May 29, 2008

(54) Managing Memory Pages During Virtual Machine Migration

(76) Inventors: William T. Newport, Rochester, MN (US); John J. Stecher, Rochester, MN (US)

Correspondence Address: IBM CORPORATION, 3605 HIGHWAY 52 NORTH, DEPT 917, ROCHESTER, MN, 55901-7829, US

(21) Appl. No.: 11/564,351

(22) Filed: Nov. 29, 2006

(51) Int. Cl. G06F 9/455

(52) U.S. Cl. 718/1

(57) ABSTRACT

A method, system and computer-readable medium is presented for migrating a virtual machine, from a first computer to a second computer, in a manner that avoids fatal page faults in the second computer. In a preferred embodiment, the method includes the steps of determining which memory pages of virtual memory are locked memory pages; migrating the virtual machine, from a first computer to a second computer, without migrating the locked memory pages; and prohibiting execution of a first instruction by the virtual machine in the second computer until the locked memory pages are migrated from the first computer to the second computer.

### BACKGROUND OF THE INVENTION

1. Technical Field

The present invention relates in general to the field of data processing, and, in particular, to computers that utilize Virtual Machines (VM). Still more particularly, the present invention relates to an improved method for migrating a VM from a first computer system to a second computer system.

2. Description of the Related Art

At a high conceptual level, a computer can be understood as hardware that, under the control of an operating system, executes instructions that are in an application program. The operating system manages and directs resources in the computer, including input/output devices, memory, etc. The application program is written and tailored to run under a specific Operating System (OS).

Early computers, as well as many modern computers, were designed to operate in a stand-alone manner using a single operating system. That is, each computer was loaded with a single particular OS, which was usually specific for a particular hardware architecture. Application programs were then written to be run on the particular hardware/OS combination.

In an effort to expand their capabilities, many computers are now able to support a Virtual Machine (VM). A virtual machine emulates hardware and operating systems through the use of software. That is, a VM can be considered to be a type of Application Program Interface (API), which takes application instructions designed to be executed under a particular OS, and creates an artificial hardware/OS environment that emulates the hardware/OS environment in which the application can run.

For example, consider the scenario shown in FIG. 1A, in which a user wants to run an application 102, which is designed to run under an Operating System A. In the scenario shown, the user can run the application 102 on a Virtual Machine (VM) 104a, which is pure software.

A single computer system (a physical machine) 106 can provide a platform for multiple virtual machines 104. Thus, as depicted, VMs 104a,b and c, which are respectively able to emulate Operating Systems A, B and C, reside within the framework provided by computer system 106. Inherently, these VMs 104 are also able to emulate the hardware required to run any of these operating systems. Thus, application 102 executes within a virtual environment, created by VM 104a, that appears to be a physical machine running Operating System A. Note that, while VM 104 emulates real hardware, at some point a physical machine 106 must do the actual work of executing instructions in an application. Thus, VM 104 provides an interface that directs the real hardware in computer system 106 to properly execute the instructions of application 102 and Operating System A, even though computer system 106 may actually be operating under an Operating System D (as depicted), or any other Operating System (including Operating Systems A, B or C) that can be interfaced by the VM 104.

As noted above, a VM is pure software, which executes within a physical machine. Oftentimes, one or more VMs will be migrated from a first physical computer box (machine “A”) to a second physical computer box (machine “B”), in order to re-allocate resources, allow the first physical box to receive maintenance, etc. Thus, as shown in FIG. 1B, VM 104 can migrate from computer system 106 to another computer system 108, both of which support virtual machine architectures. To allow a migration of a VM, a Virtual Machine Manager (VMM) 110a suspends the VM 104 on computer system 106, copies the virtual machine processor state 112, resources 114 and memory 116 of VM 104 over to computer system 108, and then resumes the VM 104 on computer system 108. Since VMM 110b, on computer system 108, can start running the VM 104 in computer system 108 before all of the memory is copied across from computer system 106, a page fault mechanism would be needed to intercept fetches to pages which have yet to be copied. The page fault mechanism would cause the VMM 110b to fetch that page from computer system 106 before resuming execution of the VM 104 on computer system 108. Unfortunately, operating systems are not designed to efficiently accommodate such page faults, since there are many different VMMs and there is no standard Application Program Interface (API) that allows operating systems to interact with such VMMs. Thus, many assumptions made by operating systems developers can be violated when such a migration is attempted. Spin locks, access to non paged memory, etc. can all take much longer than is normal in a non virtual environment. Ultimately, such code often fails in such an environment.

### SUMMARY OF THE INVENTION

To address the problems described above, the present invention presents a method, system and computer-readable medium for migrating a virtual machine, from a first computer to a second computer, in a manner that avoids fatal page faults in the second computer. In a preferred embodiment, the method includes the steps of: determining which memory pages of virtual memory are locked memory pages, wherein the virtual memory is used by a virtual machine; migrating the virtual machine, from a first computer to a second computer, without migrating the locked memory pages; and prohibiting execution of a first instruction by the virtual machine in the second computer until the locked memory pages are migrated from the first computer to the second computer.

Prior to migrating the locked pages of virtual memory from the first computer to the second computer, hard and soft architectural states may be migrated from the first computer to the virtual machine in the second computer.

Exemplary locked pages include, but are not limited to, pages of memory used by an Input/Output (IO) controller; pages that include data that is critical for timing data flow in a computer; and pages that include instructions for paging data in and out of virtual memory.

The above, as well as additional, purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1A depicts a computer system having Virtual Machine (VM) capability;

FIG. 1B illustrates a prior art method of migrating a VM from a first computer system to a second computer system;

FIGS. 2A-C depict an exemplary computer system in which a VM can be migrated to and from in accordance with the present invention;

FIGS. 3A-C depict the use of page tables in a Virtual Address to Physical Address scheme used by the present invention;

FIGS. 4A-C illustrate a high-level overview of the present inventive method of migrating a VM from a first computer system to a second computer system; and

FIG. 5 is a flow-chart of steps taken in an exemplary embodiment of the present invention for migrating a VM from a first computer system to a second computer system.

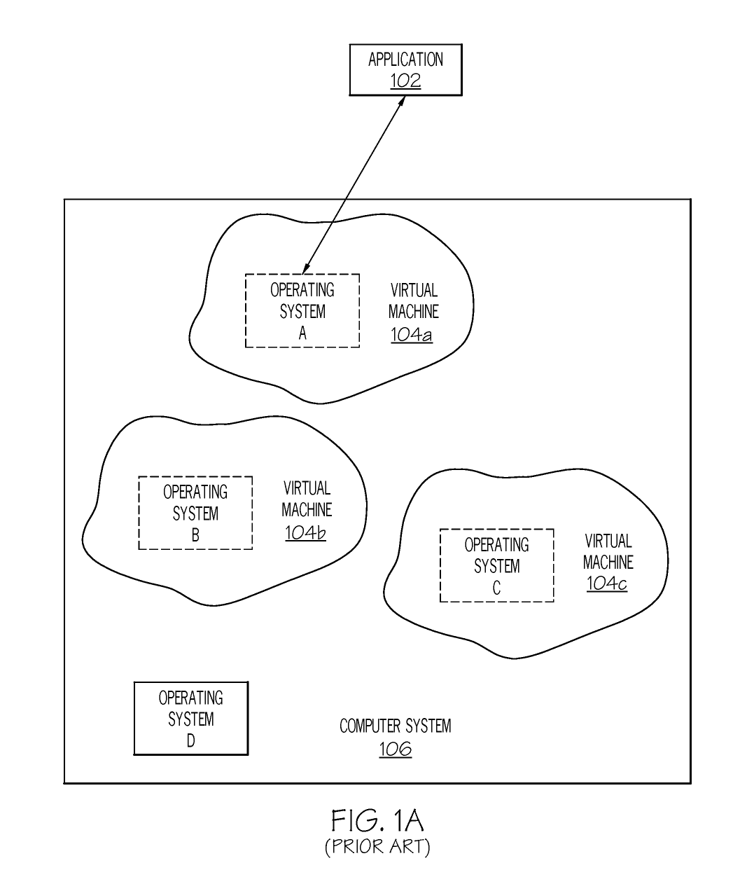

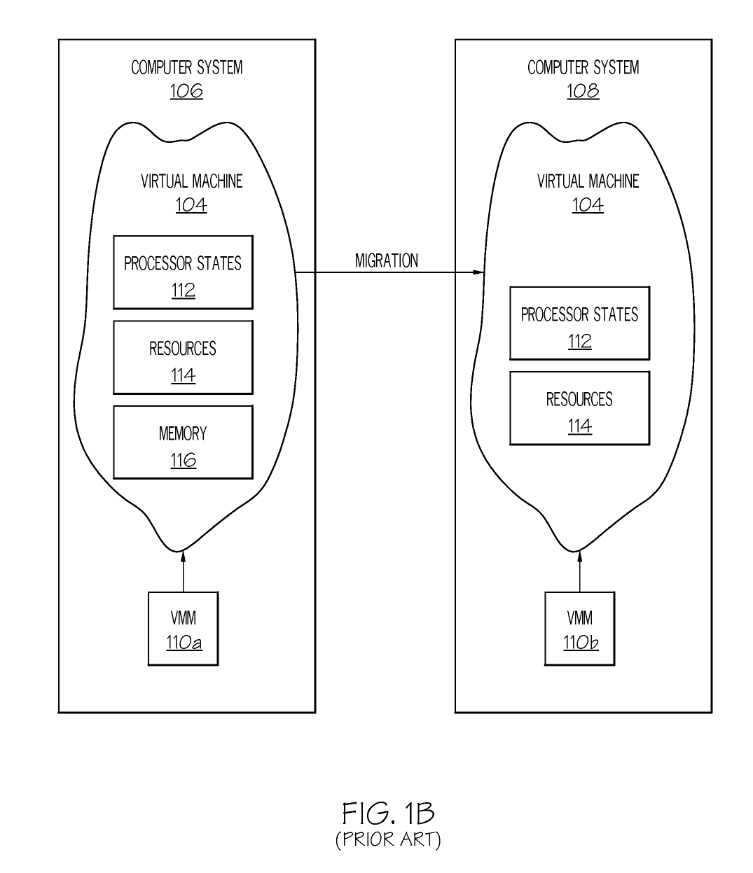

### DETAILED DESCRIPTION OF THE PREFERRED EMBODIMENT

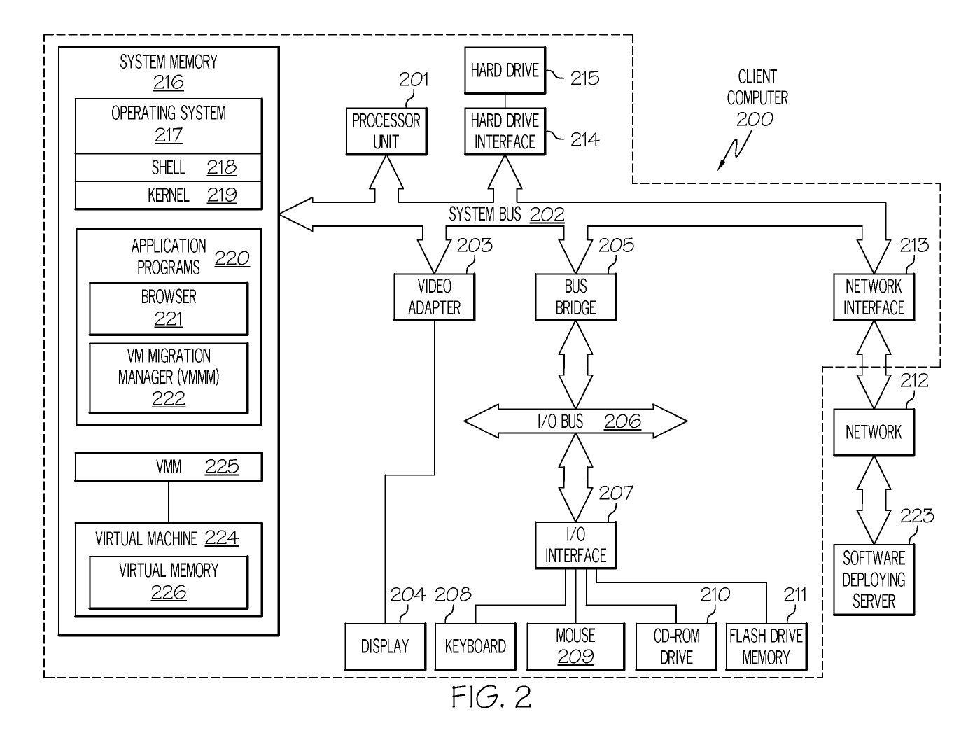

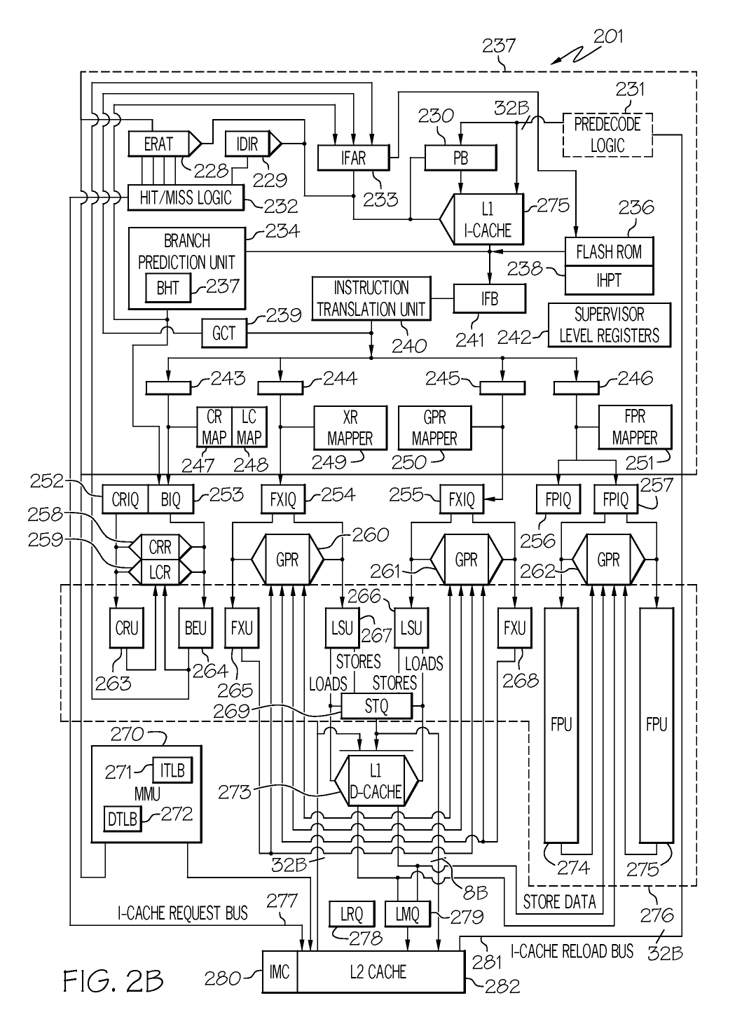

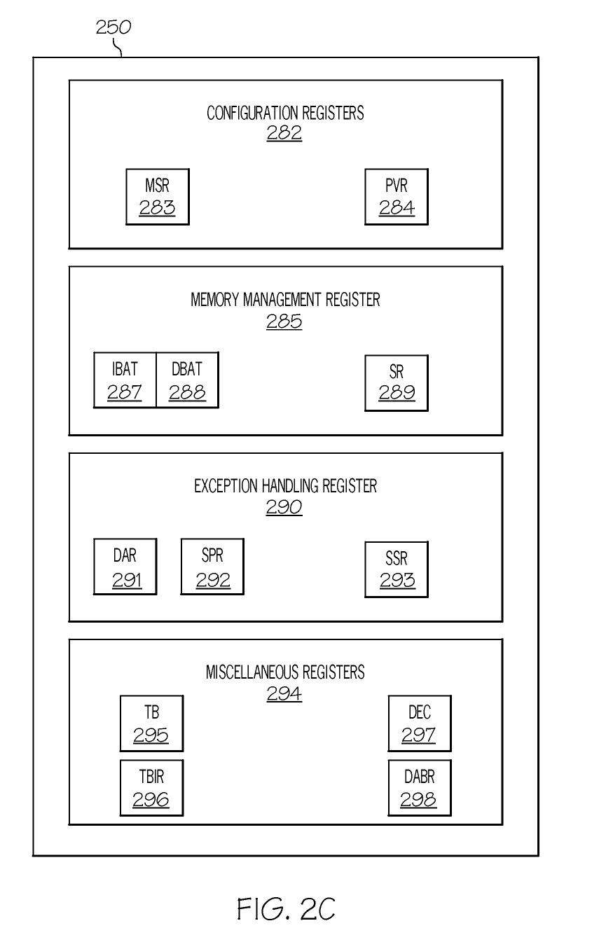

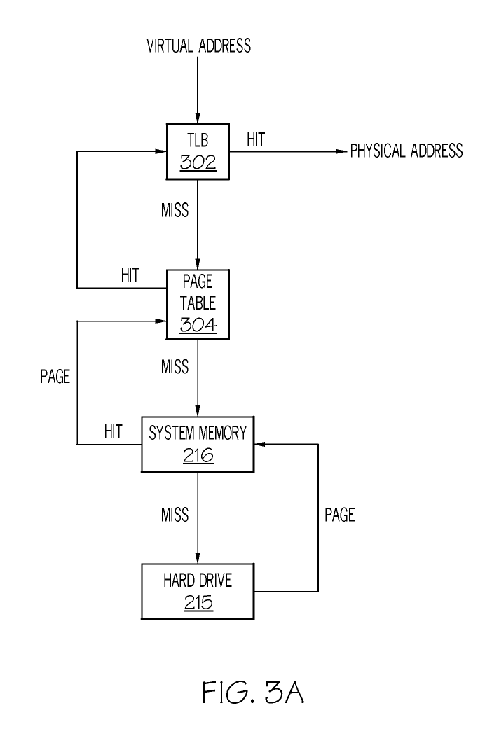

With reference now to FIG. 2A, there is depicted a block diagram of an exemplary client computer 200, in which the present invention may be utilized. Client computer 200 includes a processor unit 201 that is coupled to a system bus 202. A video adapter 203, which drives/supports a display 204, is also coupled to system bus 202. System bus 202 is coupled via a bus bridge 205 to an Input/Output (I/O) bus 206. An I/O interface 207 is coupled to I/O bus 206. I/O interface 207 affords communication with various I/O devices, including a keyboard 208, a mouse 209, a Compact Disk—Read Only Memory (CD-ROM) or other optical device drive 210, and a flash drive memory 211. The format of the ports connected to I/0 interface 207 may be any known to those skilled in the art of computer architecture, including but not limited to Universal Serial Bus (USB) ports.

Client computer 200 is able to communicate with a software deploying server 223 via a network 212 using a network interface 213, which is coupled to system bus 202. Network 212 may be an external network such as the Internet, or an internal network such as an Ethernet or a Virtual Private Network (VPN).

A hard drive interface 214 is also coupled to system bus 202. Hard drive interface 214 interfaces with a hard drive 215. In a preferred embodiment, hard drive 215 populates a system memory 216, which is also coupled to system bus 202. System memory is defined as a lowest level of volatile memory in client computer 200. This volatile memory includes additional higher levels of volatile memory (not shown), including, but not limited to, cache memory, registers and buffers. Data that populates system memory 216 includes client computer 200's operating system (OS) 217 and application programs 220.

OS 217 includes a shell 218, for providing transparent user access to resources such as application programs 220. Generally, shell 218 is a program that provides an interpreter and an interface between the user and the operating system. More specifically, shell 218 executes commands that are entered into a command line user interface or from a file. Thus, shell 218 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 219) for processing. Note that while shell 218 is a text-based, line-oriented user interface, the present invention will equally well support other user interface modes, such as graphical, voice, gestural, etc.

As depicted, OS 217 also includes kernel 219, which includes lower levels of functionality for OS 217, including providing essential services required by other parts of OS 217 and application programs 220, including memory management, process and task management, disk management, and mouse and keyboard management.

Application programs 220 include a browser 221. Browser 221 includes program modules and instructions enabling a World Wide Web (WWW) client (i.e., client computer 200) to send and receive network messages to the Internet using HyperText Transfer Protocol (HTTP) messaging, thus enabling communication with software deploying server 223. In one embodiment of the present invention, software deploying server 223 may utilize a same or substantially similar architecture as shown and described for client computer 200.

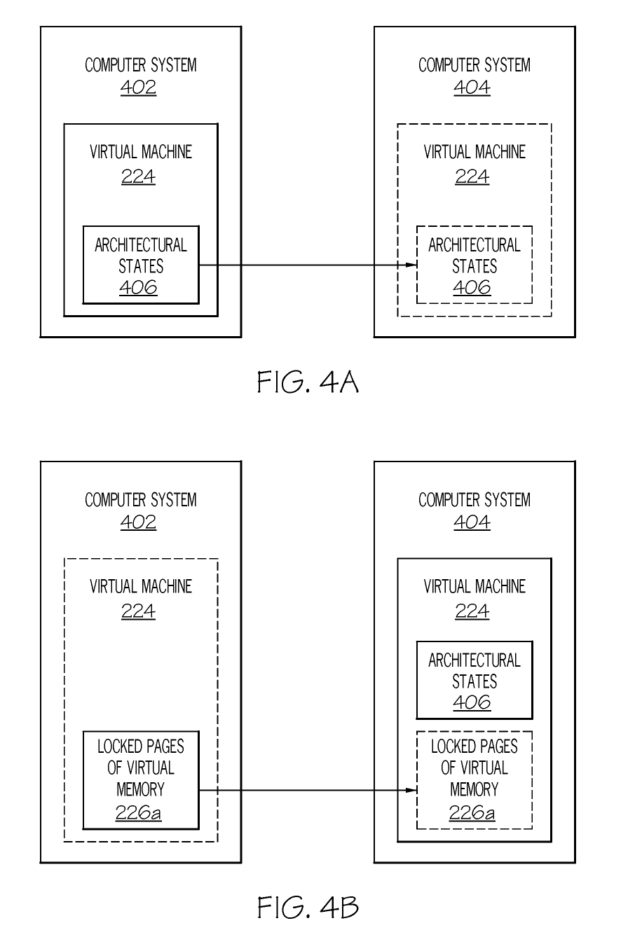

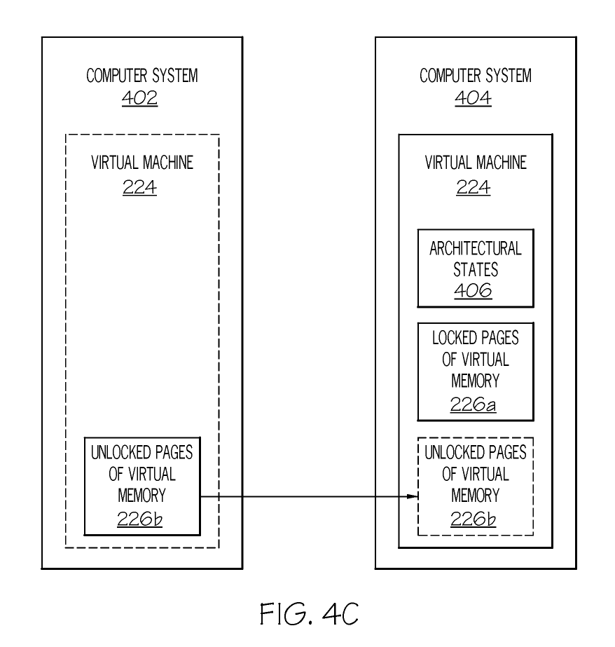

Also stored with system memory 216 is a Virtual Machine Migration Manager (VMMM) 222, which includes some or all software code needed to perform the steps described in the flowchart depicted below in FIG. 4. VMMM 222 may be deployed from software deploying server 223 to client computer 200 in any automatic or requested manner, including being deployed to client computer 200 in an on-demand basis.

Running in client computer 200 is a virtual machine 224, which is under the control and supervision of a Virtual Machine Manager (VMM) 225, and includes virtual memory 226. Additional detail of the structure and functions of VMM 225 and virtual memory 226 are presented below.

Note that the hardware elements depicted in client computer 200 are not intended to be exhaustive, but rather are representative to highlight essential components required by the present invention. For instance, client computer 200 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, software deploying server 223 performs all of the functions associated with the present invention (including execution of VMMM 222), thus freeing client computer 200 from having to use its own internal computing resources to execute VMMM 222.

Reference is now made to FIG. 2B, which shows additional detail for processing unit 201. Processing unit 201 includes an on-chip multi-level cache hierarchy including a unified level two (L2) cache 282 and bifurcated level one (L1) instruction (I) and data (D) caches 235 and 273, respectively. As is well-known to those skilled in the art, caches 282, 235 and 273 provide low latency access to cache lines corresponding to memory locations in system memories 216 (shown in FIG. 2A).

Instructions are fetched for processing from L1 I-cache 235 in response to the effective address (EA) residing in instruction fetch address register (IFAR) 233. During each cycle, a new instruction fetch address may be loaded into IFAR 233 from one of three sources: branch prediction unit (BPU) 234, which provides speculative target path and sequential addresses resulting from the prediction of conditional branch instructions, global completion table (GCT) 239, which provides flush and interrupt addresses, and branch execution unit (BEU) 264, which provides non-speculative addresses resulting from the resolution of predicted conditional branch instructions. Associated with BPU 234 is a branch history table (BHT) 237, in which are recorded the resolutions of conditional branch instructions to aid in the prediction of future branch instructions.

An effective address (EA), such as the instruction fetch address within IFAR 233, is the address of data or an instruction generated by a processor. The EA specifies a segment register and offset information within the segment. To access data (including instructions) in memory, the EA is converted to a real address (RA), through one or more levels of translation, associated with the physical location where the data or instructions are stored.

Within processing unit 201, effective-to-real address translation is performed by memory management units (MMUs) and associated address translation facilities. Preferably, a separate MMU is provided for instruction accesses and data accesses. In FIG. 2B, a single MMU 270 is illustrated, for purposes of clarity, showing connections only to instruction sequencing unit (ISU) 237. However, it is understood by those skilled in the art that MMU 270 also preferably includes connections (not shown) to load/store units (LSUs) 266 and 267 and other components necessary for managing memory accesses. MMU 270 includes data translation lookaside buffer (DTLB) 272 and instruction translation lookaside buffer (ITLB) 271. Each TLB contains recently referenced page table entries, which are accessed to translate EAs to RAs for data (DTLB 272) or instructions (ITLB 271). Recently referenced EA-to-RA translations from ITLB 271 are cached in EOP effective-to-real address table (ERAT) 228.

If hit/miss logic 232 determines, after translation of the EA contained in IFAR 233 by ERAT 228 and lookup of the real address (RA) in I-cache directory 229, that the cache line of instructions corresponding to the EA in IFAR 233 does not reside in L1 I-cache 235, then hit/miss logic 232 provides the RA to L2 cache 282 as a request address via I-cache request bus 277. Such request addresses may also be generated by prefetch logic within L2 cache 282 based upon recent access patterns. In response to a request address, L2 cache 282 outputs a cache line of instructions, which are loaded into prefetch buffer (PB) 230 and L1 I-cache 235 via I-cache reload bus 281, possibly after passing through optional predecode logic 231.

Once the cache line specified by the EA in IFAR 233 resides in L1 I-cache 235, L1 I-cache 235 outputs the cache line to both branch prediction unit (BPU) 234 and to instruction fetch buffer (IFB) 241. BPU 234 scans the cache line of instructions for branch instructions and predicts the outcome of conditional branch instructions, if any. Following a branch prediction, BPU 234 furnishes a speculative instruction fetch address to IFAR 233, as discussed above, and passes the prediction to branch instruction queue 253 so that the accuracy of the prediction can be determined when the conditional branch instruction is subsequently resolved by branch execution unit 264.

IFB 241 temporarily buffers the cache line of instructions received from L1 I-cache 235 until the cache line of instructions can be translated by instruction translation unit (ITU) 240. In the illustrated embodiment of processing unit 201, ITU 240 translates instructions from user instruction set architecture (UISA) instructions into a possibly different number of internal ISA (IISA) instructions that are directly executable by the execution units of processing unit 201. Such translation may be performed, for example, by reference to microcode stored in a read-only memory (ROM) template. In at least some embodiments, the UISA-to-IISA translation results in a different number of IISA instructions than UISA instructions and/or IISA instructions of different lengths than corresponding UISA instructions. The resultant IISA instructions are then assigned by global completion table 239 to an instruction group, the members of which are permitted to be dispatched and executed out-of-order with respect to one another. Global completion table 239 tracks each instruction group for which execution has yet to be completed by at least one associated EA, which is preferably the EA of the oldest instruction in the instruction group.

Following UISA-to-IISA instruction translation, instructions are dispatched to one of latches 243, 244, 245 and 246, possibly out-of-order, based upon instruction type. That is, branch instructions and other condition register (CR) modifying instructions are dispatched to latch 243, fixed-point and load-store instructions are dispatched to either of latches 244 and 245, and floating-point instructions are dispatched to latch 246. Each instruction requiring a rename register for temporarily storing execution results is then assigned one or more rename registers by the appropriate one of CR mapper 247, link and count (LC) register mapper 248, exception register (XER) mapper 249, general-purpose register (GPR) mapper 250, and floating-point register (FPR) mapper 251.

The dispatched instructions are then temporarily placed in an appropriate one of CR issue queue (CRIQ) 252, branch issue queue (BIQ) 253, fixed-point issue queues (FXIQs) 254 and 255, and floating-point issue queues (FPIQs) 256 and 257. From issue queues 252, 253, 254, 255, 256 and 257, instructions can be issued opportunistically to the execution units of processing unit 201 for execution as long as data dependencies and antidependencies are observed. The instructions, however, are maintained in issue queues 252-257 until execution of the instructions is complete and the result data, if any, are written back, in case any of the instructions needs to be reissued.

As illustrated, the execution units of processing unit 201 include a CR unit (CRU) 263 for executing CR-modifying instructions, a branch execution unit (BEU) 264 for executing branch instructions, two fixed-point units (FXUs) 265 and 268 for executing fixed-point instructions, two load-store units (LSUs) 266 and 267 for executing load and store instructions, and two floating-point units (FPUs) 274 and 275 for executing floating-point instructions. Each of execution units 263-275 is preferably implemented as an execution pipeline having a number of pipeline stages.

During execution within one of execution units 263-275, an instruction receives operands, if any, from one or more architected and/or rename registers within a register file coupled to the execution unit. When executing CR-modifying or CR-dependent instructions, CRU 263 and BEU 264 access the CR register file 258, which in a preferred embodiment contains a CR and a number of CR rename registers that each comprise a number of distinct fields formed of one or more bits. Among these fields are LT, GT, and EQ fields that respectively indicate if a value (typically the result or operand of an instruction) is less than zero, greater than zero, or equal to zero. Link and count register (LCR) register file 259 contains a count register (CTR), a link register (LR) and rename registers of each, by which BEU 264 may also resolve conditional branches to obtain a path address. General-purpose register files (GPRs) 260 and 261, which are synchronized, duplicate register files, store fixed-point and integer values accessed and produced by FXUs 265 and 268 and LSUs 266 and 267. Floating-point register file (FPR) 262, which like GPRs 260 and 261 may also be implemented as duplicate sets of synchronized registers, contains floating-point values that result from the execution of floating-point instructions by FPUs 274 and 275 and floating-point load instructions by LSUs 266 and 267.

After an execution unit finishes execution of an instruction, the execution notifies GCT 239, which schedules completion of instructions in program order. To complete an instruction executed by one of CRU 263, FXUs 265 and 268 or FPUs 274 and 275, GCT 239 signals the execution unit, which writes back the result data, if any, from the assigned rename register(s) to one or more architected registers within the appropriate register file. The instruction is then removed from the issue queue, and once all instructions within its instruction group have completed, is removed from GCT 239. Other types of instructions, however, are completed differently.

When BEU 264 resolves a conditional branch instruction and determines the path address of the execution path that should be taken, the path address is compared against the speculative path address predicted by BPU 234. If the path addresses match, no further processing is required. If, however, the calculated path address does not match the predicted path address, BEU 264 supplies the correct path address to IFAR 233. In either event, the branch instruction can then be removed from BIQ 253, and when all other instructions within the same instruction group have completed, from GCT 239.

Following execution of a load instruction, the effective address computed by executing the load instruction is translated to a real address by a data ERAT (not illustrated) and then provided to L1 D-cache 273 as a request address. At this point, the load instruction is removed from FXIQ 254 or 255 and placed in load reorder queue (LRQ) 278 until the indicated load is performed. If the request address misses in L1 D-cache 273, the request address is placed in load miss queue (LMQ) 279, from which the requested data is retrieved from L2 cache 282 (which is under the control of an Instruction Memory Controller (IMC) 280), and failing that, from another processing unit 201 or from system memory 216 (shown in FIG. 2A). LRQ 278 snoops exclusive access requests (e.g., read-with-intent-to-modify), flushes or kills on an interconnect fabric against loads in flight, and if a hit occurs, cancels and reissues the load instruction. Store instructions are similarly completed utilizing a store queue (STQ) 269 into which effective addresses for stores are loaded following execution of the store instructions. From STQ 269, data can be stored into either or both of L1 D-cache 273 and L2 cache 282.

### Processor States

The states of a processor includes stored data, instructions and hardware states at a particular time, and are herein defined as either being “hard” or “soft.” The “hard” state is defined as the information within a processor that is architecturally required for a processor to execute a process from its present point in the process. The “soft” state, by contrast, is defined as information within a processor that would improve efficiency of execution of a process, but is not required to achieve an architecturally correct result. In processing unit 201 of FIG. 2A, the hard state includes the contents of user-level registers, such as CRR 258, LCR 259, GPRs 260 and 261, FPR 262, as well as supervisor level registers 242. The soft state of processing unit 201 includes both “performance-critical” information, such as the contents of L-1 I-cache 235, L-1 D-cache 273, address translation information such as DTLB 272 and ITLB 271, and less critical information, such as BHT 237 and all or part of the content of L2 cache 282.

The hard architectural state is stored to system memory through the load/store unit of the processor core, which blocks execution of the interrupt handler or another process for a number of processor clock cycles. Alternatively, upon receipt of an interrupt, processing unit 201 suspends execution of a currently executing process, such that the hard architectural state stored in hard state registers is then copied directly to shadow register. The shadow copy of the hard architectural state, which is preferably non-executable when viewed by the processing unit 201, is then stored to system memory 216. The shadow copy of the hard architectural state is preferably stored in a special memory area within system memory 216 that is reserved for hard architectural states.

Saving soft states differs from saving hard states. When an interrupt handler is executed by a conventional processor, the soft state of the interrupted process is typically polluted. That is, execution of the interrupt handler software populates the processor's caches, address translation facilities, and history tables with data (including instructions) that are used by the interrupt handler. Thus, when the interrupted process resumes after the interrupt is handled, the process will experience increased instruction and data cache misses, increased translation misses, and increased branch mispredictions. Such misses and mispredictions severely degrade process performance until the information related to interrupt handling is purged from the processor and the caches and other components storing the process' soft state are repopulated with information relating to the process. Therefore, at least a portion of a process' soft state is saved and restored in order to reduce the performance penalty associated with interrupt handling. For example, the entire contents of L1 I-cache 235 and L1 D-cache 273 may be saved to a dedicated region of system memory 216. Likewise, contents of BHT 237, ITLB 271 and DTLB 272, ERAT 228, and L2 cache 282 may be saved to system memory 216.

Because L2 cache 282 may be quite large (e.g., several megabytes in size), storing all of L2 cache 282 may be prohibitive in terms of both its footprint in system memory and the time/bandwidth required to transfer the data. Therefore, in a preferred embodiment, only a subset (e.g., two) of the most recently used (MRU) sets are saved within each congruence class.

Thus, soft states may be streamed out while the interrupt handler routines (or next process) are being executed. This asynchronous operation (independent of execution of the interrupt handlers) may result in an intermingling of soft states (those of the interrupted process and those of the interrupt handler). Nonetheless, such intermingling of data is acceptable because precise preservation of the soft state is not required for architected correctness and because improved performance is achieved due to the shorter delay in executing the interrupt handler.

### Registers

In the description above, register files of processing unit 201 such as GPR 261, FPR 262, CRR 258 and LCR 259 are generally defined as “user-level registers,” in that these registers can be accessed by all software with either user or supervisor privileges. Supervisor level registers 242 include those registers that are used typically by an operating system, typically in the operating system kernel, for such operations as memory management, configuration and exception handling. As such, access to supervisor level registers 242 is generally restricted to only a few processes with sufficient access permission (i.e., supervisor level processes).

As depicted in FIG. 2C, supervisor level registers 242 generally include configuration registers 283, memory management registers 286, exception handling registers 290, and miscellaneous registers 294, which are described in more detail below.

Configuration registers 283 include a machine state register (MSR) 284 and a processor version register (PVR) 285. MSR 284 defines the state of the processor. That is, MSR 285 identifies where instruction execution should resume after an instruction interrupt (exception) is handled. PVR 285 identifies the specific type (version) of processing unit 201.

Memory management registers 286 include block-address translation (BAT) registers 287-288. BAT registers 287-288 are software-controlled arrays that store available block-address translations on-chip. Preferably, there are separate instruction and data BAT registers, shown as IBAT 287 and DBAT 288. Memory management registers also include segment registers (SR) 289, which are used to translate EAs to virtual addresses (VAs) when BAT translation fails.

Exception handling registers 290 include a data address register (DAR) 291, special purpose registers (SPRs) 292, and machine status save/restore (SSR) registers 293. The DAR 291 contains the effective address generated by a memory access instruction if the access causes an exception, such as an alignment exception. SPRs are used for special purposes defined by the operating system, for example, to identify an area of memory reserved for use by a first-level exception handler (FLIH). This memory area is preferably unique for each processor in the system. An SPR 292 may be used as a scratch register by the FLIH to save the content of a general purpose register (GPR), which can be loaded from SPR 292 and used as a base register to save other GPRs to memory. SSR registers 293 save machine status on exceptions (interrupts) and restore machine status when a return from interrupt instruction is executed.

Miscellaneous registers 294 include a time base (TB) register 295 for maintaining the time of day, a decrementer register (DEC) 297 for decrementing counting, and a data address breakpoint register (DABR) 298 to cause a breakpoint to occur if a specified data address is encountered. Further, miscellaneous registers 294 include a time based interrupt register (TBIR) 296 to initiate an interrupt after a pre-determined period of time. Such time based interrupts may be used with periodic maintenance routines to be run on processing unit 201.

### SLIH/FLIH Flash Rom

First Level Interrupt Handlers (FLIHs) and Second Level Interrupt Handlers (SLIHs) may also be stored in system memory, and populate the cache memory hierarchy when called. Normally, when an interrupt occurs in processing unit 201, a FLIH is called, which then calls a SLIH, which completes the handling of the interrupt. Which SLIH is called and how that SLIH executes varies, and is dependent on a variety of factors including parameters passed, conditions states, etc. Because program behavior can be repetitive, it is frequently the case that an interrupt will occur multiple times, resulting in the execution of the same FLIH and SLIH. Consequently, the present invention recognizes that interrupt handling for subsequent occurrences of an interrupt may be accelerated by predicting that the control graph of the interrupt handling process will be repeated and by speculatively executing portions of the SLIH without first executing the FLIH. To facilitate interrupt handling prediction, processing unit 201 is equipped with a flash ROM 236 that includes an Interrupt Handler Prediction Table (IHPT) 238. IHPT 238 contains a list of the base addresses (interrupt vectors) of multiple FLIHs. In association with each FLIH address, IHPT 238 stores a respective set of one or more SLIH addresses that have previously been called by the associated FLIH. When IHPT 238 is accessed with the base address for a specific FLIH, a prediction logic selects a SLIH address associated with the specified FLIH address in IHPT 238 as the address of the SLIH that will likely be called by the specified FLIH. Note that while the predicted SLIH address illustrated may be the base address of the SLIH, the address may also be an address of an instruction within the SLIH subsequent to the starting point (e.g., at point B).

Prediction logic uses an algorithm that predicts which SLIH will be called by the specified FLIH. In a preferred embodiment, this algorithm picks a SLIH, associated with the specified FLIH, which has been used most recently. In another preferred embodiment, this algorithm picks a SLIH, associated with the specified FLIH, which has historically been called most frequently. In either described preferred embodiment, the algorithm may be run upon a request for the predicted SLIH, or the predicted SLIH may be continuously updated and stored in IHPT 238.

### State Management

Management of both soft and hard architectural states may be managed by a hypervisor, which is accessible by multiple processors within any partition. That is, Processor A and Processor B may initially be configured by the hypervisor to function as an SMP within Partition X, while Processor C and Processor D are configured as an SMP within Partition Y. While executing, processors A-D may be interrupted, causing each of processors A-D to store a respective one of hard states A-D and soft states A-D to memory in the manner discussed above. Any processor can access any of hard or soft states A-D to resume the associated interrupted process. For example, in addition to hard and soft states C and D, which were created within its partition, Processor D can also access hard and soft states A and B. Thus, any process state can be accessed by any partition or processor(s). Consequently, the hypervisor has great freedom and flexibility in load balancing between partitions.

### Virtual Addresses

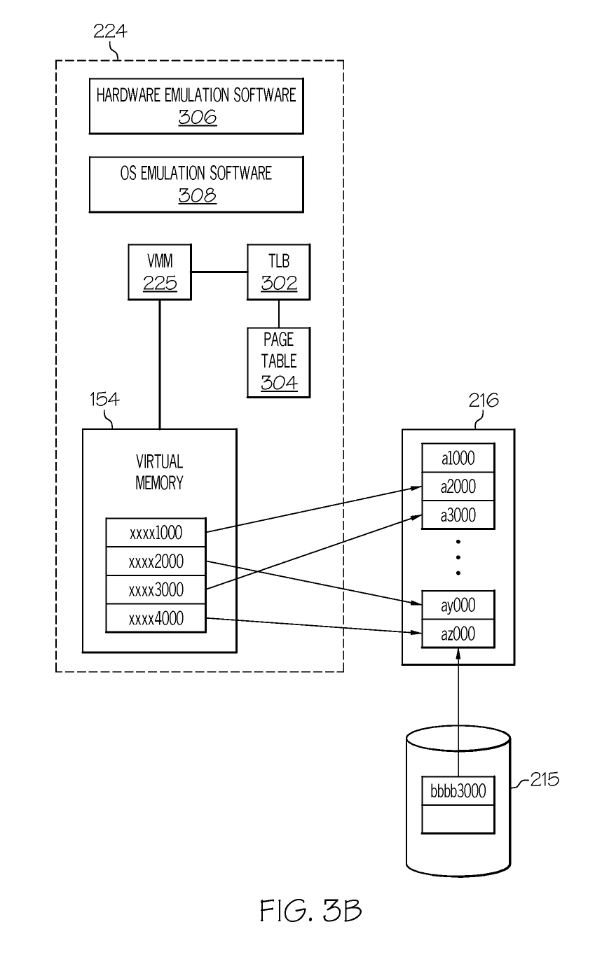

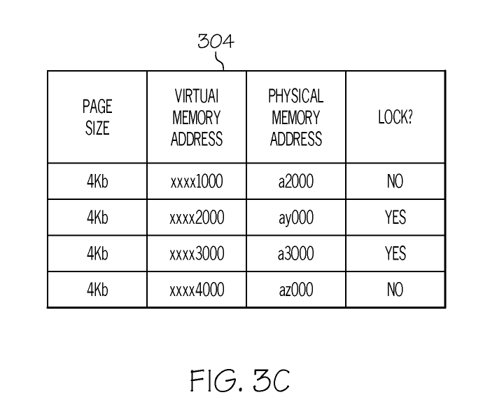

With reference now to FIG. 3A, an overview of how a virtual address (used by a Virtual Machine—VM) is utilized in accordance with the present invention. Virtual machines use virtual memory that has virtual addresses. The virtual memory is larger than the actual physical memory (system memory) in a computer, and the virtual addresses can be contiguous (although the actual system memory addresses are not). Thus, virtual memory can be considered to be a fast memory mapping system. For example, consider a VM sending a request for a page of memory at a virtual address, as shown in FIG. 3A. This virtual address is first sent to a Translation Lookaside Buffer (TLB) 302, which is a cache of physical addresses that correspond with virtual addresses, and is conceptually similar to the ITLB 271 and DTLB 272 described in FIG. 2B. If the virtual/physical address pair is found in the TLB 302, this is called a “Hit,” and the page of memory from the system memory is returned to the VM using the physical address. However, if the TLB 302 does not have the virtual/physical address pair (“Miss”), then the virtual/physical address pair is searched for in a page table 304, which is describe in further detail in FIG. 3B. If the virtual/physical address pair is not found in the page table 304, then system memory 216 is first examined to find the needed memory page. If the needed memory page is not located in system memory 216, then it is pulled from the hard drive 215, and loaded into system memory 216 at a physical address that is provided to the page table 304 (and TLB 302).

With reference now to FIG. 3B, additional detail of the VM 224 shown in FIG. 2A is presented. VM 224 includes hardware emulation software 306 and OS emulation software 308. As their names suggest, hardware emulation software 306 provides a virtual hardware environment, which OS emulation software 308 is able to emulate one or more OSes.

When VM 224 requests a memory page from virtual memory 226, Virtual Memory Manager (VMM) 225 directs this request using TLB 302 and page table 304. Thus, assume that VM 224 needs the memory pages that start at virtual memory addresses “xxxx1000”, “xxxx2000”, “xxxx3000” and “xxxx4000.” These virtual addresses respectively correspond with physical addresses “a2000”, “ay000”, “a3000” and “az000” in system memory 216. Note that, when first requested, the memory page for “xxxx4000” was not in system memory 216, and thus had to be “paged in” from the memory page found at address “bbbb3000” in hard drive 215.

With reference now to FIG. 3C, additional detail is shown for page table 304. Besides showing the size of each page (shown in exemplary manner as being 4 Kb, although any size page supported by the VM 224 may be used), each virtual memory address is mapped with a physical memory address at which a memory page begins. Furthermore, each page is flagged as being “Locked” or “Unlocked.” A locked page is one that cannot be paged out (moved from system memory to secondary memory). Examples of such locked pages include, but are not limited to, pages of memory used by an Input/Output (IO) controller; pages that include data that is critical for timing data flow in a computer; and pages that include instructions for paging data in and out of virtual memory. That is, a locked page is one that, if it were to be paged out, some type of fault would likely result.

### Virtual Machine Migration

Referring now to FIGS. 4A-C, a graphical overview of how a virtual machine is migrated, in accordance with the present invention, from a first computer system 402 to a second computer system 404 is presented. (Note that the architecture shown in FIGS. 2A-C is an exemplary architecture that may be used by first computer system 402 and second computer system 404.) As shown in FIG. 4A, the first step in the migration of VM 406 is to migrate the architectural states 406. These architectural states 406 may be either hard or soft architectural states of computer system 402, as described above, and include, but are not limited to, the contents of user-level registers, such as CRR 258, LCR 259, GPRs 260 and 261, FPR 262, as well as supervisor level registers 242. The architectural states 406 found in supervisor level registers 242 include some or all of the contents of the configuration registers 283, memory management registers 286, exception handling registers 290, and miscellaneous registers 294. As described above, the soft states include both “performance-critical” information, such as the contents of L-1 I-cache 235, L-1 D-cache 273, address translation information such as DTLB 272 and ITLB 271; as well as less critical information, such as BHT 237 and all or part of the content of L2 cache 282. Thus, the architectural state of the processor of first computer system 402 may include any register, table, buffer, directory or mapper described in FIGS. 2B-C.

As shown in FIG. 4B, after the architectural states 406 have been migrated (as well as a listing of resources available to the Virtual Machine (VM) 224), locked pages (described above and denoted as that found in virtual memory 226a) are migrated from computer system 402 to computer system 404. At some later time (after VM 224 begins executing instructions in computer system 404), the rest of virtual memory 226b (the unlocked pages) are migrated to computer system 404, as depicted in FIG. 4C.

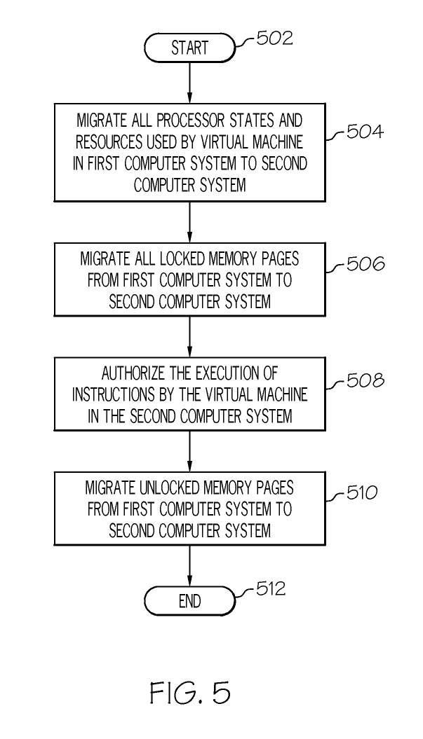

Referring now to FIG. 5, a flow-chart of exemplary steps taken by the present invention when migrating a VM is presented. After initiator block 502, all processor states and resources used by the VM in the first computer system are migrated to the second computer system (block 504). Note that the first computer system and the second computer system may be in physically different housings (boxes), or they may be logical partitions in a same computer system.

After the processor states and resources have been migrated to the second computer system, all locked memory pages are migrated from the first computer system to the second computer system (block 506). It is only after these locked memory pages have been migrated that the VM is authorized and enabled to begin executing instructions in the second computer system (block 508). (By preventing the use of the VM before the locked pages are migrated, the problems such as spin locks, paging failures, etc. is avoided.) Thereafter, the rest of the memory pages (unlocked pages) are migrated to the second computer system (block 510), thus avoiding page faults in the second computer system, and the process ends (terminator block 512).

It is to be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media, including but not limited to tangible computer-readable media, when carrying or encoded with a computer program having computer readable instructions that direct method functions in the present invention, represent alternative embodiments of the present invention. Further, it is understood that the present invention may be implemented by a system having means in the form of hardware, software, or a combination of software and hardware as described herein or their equivalent.

Thus, in one embodiment, the present invention may be implemented through the use of a computer-readable medium encoded with a computer program that, when executed, performs the inventive steps described and claimed herein.

As described herein, the present invention provides for a method, system, and computer-readable medium for migrating a virtual machine from a first computer to a second computer in a manner that avoids fatal page faults. In a preferred embodiment, the method includes the steps of: determining which memory pages of virtual memory are locked memory pages, wherein the virtual memory is used by a virtual machine; migrating the virtual machine, from a first computer to a second computer, without migrating the locked memory pages; and prohibiting execution of a first instruction by the virtual machine in the second computer until the locked memory pages are migrated from the first computer to the second computer.

Prior to migrating the locked pages of virtual memory from the first computer to the second computer, hard and soft architectural states may be migrated from the first computer to the virtual machine in the second computer. Exemplary locked pages include, but are not limited to, pages of memory used by an Input/Output (IO) controller; pages that include data that is critical for timing data flow in a computer; and pages that include instructions for paging data in and out of virtual memory.

While the invention has been particularly shown and described with reference to a preferred embodiment, it will be understood by those skilled in the art that various changes in form and detail may be made therein without departing from the spirit and scope of the invention.

What is claimed is:

1. A method for migrating a virtual machine from a first computer to a second computer, the method comprising:
determining which memory pages of virtual memory are locked memory pages, wherein the virtual memory is used by a virtual machine;
migrating the virtual machine, from a first computer to a second computer, without migrating the locked memory pages; and
prohibiting execution of a first instruction by the virtual machine in the second computer until the locked memory pages are migrated from the first computer to the second computer.

2. The method of claim 1, further comprising:
prior to migrating the locked pages of virtual memory from the first computer to the second computer, migrating hard architectural states of the first computer to the virtual machine in the second computer.

3. The method of claim 1, further comprising:
prior to migrating the locked pages of virtual memory from the first computer to the second computer, migrating soft architectural states of the first computer to the virtual machine in the second computer.

4. The method of claim 1, wherein the locked pages are pages of memory used by an Input/Output (IO) controller.

5. The method of claim 1, wherein the locked pages include data that is critical for timing data flow in a computer.

6. The method of claim 1, wherein the locked pages include instructions for paging data in and out of virtual memory.

7. A system comprising:
a processor;
a data bus coupled to the processor;
a memory coupled to the data bus; and
a computer-usable medium embodying computer program code, the computer program code comprising instructions executable by the processor and configured for:
determining which memory pages of virtual memory are locked memory pages, wherein the virtual memory is used by a virtual machine;
migrating the virtual machine, from a first computer to a second computer, without migrating the locked memory pages; and
prohibiting execution of a first instruction by the virtual machine in the second computer until the locked memory pages are migrated from the first computer to the second computer.

8. The system of claim 7, wherein the instructions are further configured for:
prior to migrating the locked pages of virtual memory from the first computer to the second computer, migrating hard architectural states of the first computer to the virtual machine in the second computer.

9. The system of claim 7, wherein the instructions are further configured for:
prior to migrating the locked pages of virtual memory from the first computer to the second computer, migrating soft architectural states of the first computer to the virtual machine in the second computer.

10. The system of claim 7, wherein the locked pages are pages of memory used by an Input/Output (IO) controller.

11. The system of claim 7, wherein the locked pages include data that is critical for timing data flow in a computer.

12. The system of claim 7, wherein the locked pages include instructions for paging data in and out of virtual memory.

13. A computer-readable medium encoded with computer program code for sharing kindred registry data between an older version of a configuration file and a newer version of a configuration file, the computer program code comprising computer executable instructions configured for:
determining which memory pages of virtual memory are locked memory pages, wherein the virtual memory is used by a virtual machine;
migrating the virtual machine, from a first computer to a second computer, without migrating the locked memory pages; and
prohibiting execution of a first instruction by the virtual machine in the second computer until the locked memory pages are migrated from the first computer to the second computer.

14. The computer-readable medium of claim 13, wherein the computer executable instructions are further configured for:
prior to migrating the locked pages of virtual memory from the first computer to the second computer, migrating hard architectural states of the first computer to the virtual machine in the second computer.

15. The computer-readable medium of claim 13, wherein the computer executable instructions are further configured for:
prior to migrating the locked pages of virtual memory from the first computer to the second computer, migrating soft architectural states of the first computer to the virtual machine in the second computer.

16. The computer-readable medium of claim 13, wherein the locked pages are pages of memory used by an Input/Output (IO) controller.

17. The computer-readable medium of claim 13, wherein the locked pages include data that is critical for timing data flow in a computer.

18. The computer-readable medium of claim 13, wherein the locked pages include instructions for paging data in and out of virtual memory.

19. The computer-readable medium of claim 13, wherein the computer executable instructions are deployable from a client computer to a software deploying server that is at a remote location.

20. The computer-readable medium of claim 13, wherein the computer executable instructions are provided by a client computer to a software deploying server in an on-demand basis.
